(19) United States
(12) Patent Application Publication
(10) Pub. No.: US 2007/0064621 A1
(43) Pub. Date: Mar. 22, 2007

(54) Method and system for testing network configurations

(76) Inventors: Michael Edward Luken, Durham, NC (US); Mark David Manzanares, San Jose, CA (US); Gang Wu, San Ramon, CA (US); Raj Kiran, Bangalore (IN); Nathan Gregory Menachem LAX, Ottawa (CA); Robert Ian Jennings, Kanata (CA); Tibor Fabry-Asztalos, Santa Clara, CA (US)

Correspondence Address: WAGNER, MURABITO & HAO LLP, Third Floor, Two North Market Street, San Jose, CA, 95113, US

(21) Appl. No.: 11/149,064

(22) Filed: Jun. 8, 2005

(51) Int. Cl. H04L 12/28

(52) U.S. Cl. 370/254

(57) ABSTRACT

A method for testing network configurations. Specifically, a plurality of source requirements is determined for a network configuration, wherein the plurality of source requirements describe physical and functional characteristics of the network configuration. Each of the plurality of source requirements is linked to at least one of a plurality of common elements. Also, each of the plurality of common elements is associated with one or more source requirements supporting one or more network configurations. A plurality of test requirements is provided for testing the plurality of common elements. Also, the plurality of source requirements are mapped to at least one of the plurality of test requirements through the plurality of common elements.

### BACKGROUND OF THE INVENTION

1. Field of the Invention

Embodiments of the present invention relate to the field of network configuration design. More particularly, embodiments of the present invention relate generally to linking network configuration requirements and testing of those configuration requirements through common elements.

2. Related Art

The design of network configurations is a complicated process that includes determining what requirements are needed by a customer and determining what network configuration can support those requirements. Typically, a coordinator through experience and knowledge is able to design a network configuration that supports the requirements specified by the customer.

The design of the network configuration includes a testing phase to determine if the network configuration can support the requirements specified by customer. Typically, testing of a network configuration may be conducted by one or more independent testing groups that focus on different aspects of the network configuration.

However, a common problem for the coordinator and the testing groups is determining what testing environment or situation of the network configuration needs to be tested and correctly assigning the testing to the various testing groups. Additionally, tracking the test results of various testing groups that are testing the network configuration is manually accomplished by the coordinator. This tracking process can become unwieldy as the number of tests and the complexity of the network configuration increases.

As a result, there may be overlapping testing of various requirements of the network configuration by the various testing groups, or missing test of some requirements. Typically, the testing groups operate autonomously and develop different solutions for determining what to test and tracking test results. Because of the autonomous operation and the incompatibility between testing solutions, it is difficult to quickly ascertain when overlapping of testing occurs between two or more testing groups, or if any requirements are missed in testing.

In addition, the manual process for determining which tests and testing groups are selected may create an incomplete vision of the test coverage. This incomplete vision of the test coverage may create a gap in testing, such as testing for a particular requirement required by customer and supposedly supported by the network configuration.

As a result, because of the numbers of testing groups involved and the incompatibility between the testing groups, there exist problems of overlapping coverage, test gap, and a lack of visibility into the testing coverage. As such, customers, in order to get their requirements tested, are forced to interact with a large number of testing groups, often resulting in missed coverage gaps in the design, unclear testing assignments, etc.

### BRIEF DESCRIPTION OF THE DRAWINGS

FIG. 1 is a block diagram of an electronic device that is capable of testing a network configuration using a common test interface, in accordance with one embodiment of the present invention.

FIG. 2 is a diagram of a network illustrating the functions of a network resource, in accordance with one embodiment of the present invention.

FIG. 3 is a data flow diagram illustrating the interrelationship between a source defined network configuration design environment and a testing environment testing the network configuration, in accordance with one embodiment of the present invention.

FIG. 4 is a flow chart illustrating steps in a computer implemented method for testing network configurations using a common test interface, in accordance with one embodiment of the present invention.

FIG. 5 illustrates a block diagram of a common test interface system that implements the method for testing network configurations of FIG. 4, in accordance with one embodiment of the present invention.

FIG. 6 is a diagram of a CTI interface network that illustrates the entire CTI process in testing a network configuration, in accordance with one embodiment of the present invention.

FIG. 7A is a diagram illustrating the interrelationships between Atomic Test Elements (ATEs) and packet flow profiles (PFPs) as well as control plane profiles (CPPs), in accordance with one embodiment of the present invention.

FIG. 7B is a diagram illustrating the interrelationships between SEAs, ATEs, and profiles, in accordance with one embodiment of the present invention.

FIG. 7C is a diagram illustrating the interrelationship between Network Characteristics and Test Activities through common elements, in accordance with one embodiment of the present invention.

FIG. 8 provides a diagram 800 illustrating the interrelationship between the source block and the testing blocks, in accordance with one embodiment of the present invention.

### DETAILED DESCRIPTION OF THE INVENTION

Reference will now be made in detail to the preferred embodiments of the present invention, a method and system for testing network configuration using a common test interface (CTI) that links a testing environment with a network design environment through common elements, examples of which are illustrated in the accompanying drawings.

Accordingly, various embodiments of the present invention disclose a method and system for testing network configuration through a common test interface that allows test results and test requirements to be expressed in common elements using one language or schema. Embodiments of the present invention are capable of providing a quick comparison between the source requirements requested by the customers and the test results from the various testing groups tasked to test the source requirements. As a result, the CTI interface provides for common elements that are flexible for use by network design environment and the various testing environments, which consolidates requirements tracking, result reporting, and quality analysis. The CTI provides an interface to universally track testing and source requirements for all customers and all testing groups using one language or schema supporting the CTI interface.

Notation and Nomenclature

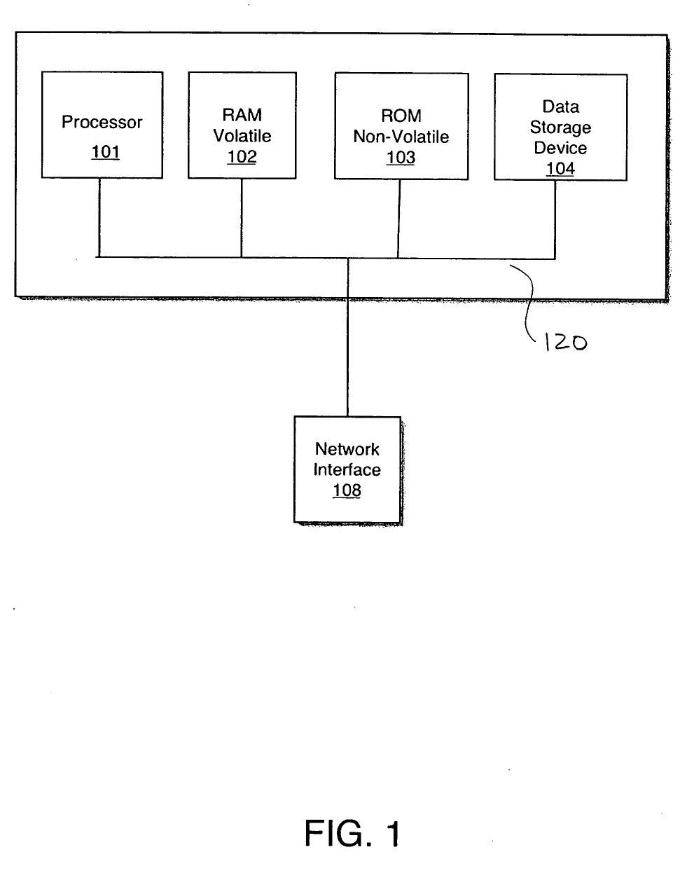

Referring now to FIG. 1, portions of the present invention are comprised of computer-readable and computer-executable instructions which reside, for example, in computer-readable media of an electronic system that are capable of accessing networked devices, such as, a server computer, mainframe, networked computer, workstation, hub, router, switch, firewall, access server, and the like. FIG. 1 is a block diagram of interior components of an exemplary electronic system 100, upon which embodiments of the present invention may be implemented.

Exemplary electronic system 100 includes an address/data bus 120, a volatile memory 102 (e.g., random access memory (RAM), static RAM dynamic RAM, etc.), and a non-volatile memory 103 (e.g., read only memory (ROM), programmable ROM, flash memory, EPROM, EEPROM, etc.) coupled to the bus 120 for storing static information and instructions for the processor 101.

Exemplary electronic system 100 also includes an optional data storage device 104 (e.g., cache memory, memory card, hard drive, etc.) coupled with the bus 120 for storing information and instructions. Data storage device 104 is removable, in one embodiment. With reference still to FIG. 1, a network interface 108 (e.g., signal input/output device) is provided which is coupled to bus 120 for providing a communication link between electronic system 100 and a network environment. As such network interface 108 enables network communication through the device, and/or the central processor unit 101 to communicate with or monitor other electronic systems (e.g., networked devices).

Some portions of the detailed descriptions are presented in terms of procedures, steps, logic blocks, processing, and other symbolic representations of operations. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “determining,” “linking,” “providing,” “mapping,” “validating,” or the like, refer to the action and processes of a computer system, or similar electronic computing device, including an embedded system, that manipulates and transforms data represented as physical (electronic) quantities within the computer system's registers and memories into other data similarly represented as physical quantities within the computer system memories or registers or other such information storage, transmission or display devices.

Method and System for Testing Networked Devices

In accordance with one embodiment of the present invention, the CTI interface is designed to provide the framework, methodology, and tooling for defining, managing, and reporting against source requirements for designing a network configuration. The CTI interface provides, in a structured manner, the ability to define source requirements, validation of these source requirements, collection/grouping of these requirements, and mapping of these requirements and groupings into test cases. That is, the CTI interface of embodiments of the present invention provides a formal and systemic approach for executing testing against source specific requirements. As a result, embodiments of the present invention are capable of quickly perform gap analysis, track quality for specific source requirements, and evaluate efficiency of testing.

The CTI interface provides a bridge between testing activities and source requirements specified by a source or customer designing a network configuration, in accordance with one embodiment of the present invention. More specifically, the CTI interface includes a common methodology to capture and describe system test requirements for both customer oriented and system integration testing efforts. Additionally, the present embodiment provides for the ability to track test coverage per customer and/or internal requirements.

The core component of the CTI interface is the “common element,” in accordance with one embodiment of the present invention. The common element is the set of data storage concepts provided to capture the essence of testable requirements. The common element is implemented within a common language or schema that supports the CTI interface. In accordance with one embodiment of the present invention, the common elements combine into a set of three different entities: Atomic Test Elements (ATEs), Profiles, and SEAs (Stimulus, Events, and Activities).

The ATE is a fundamental building block for the CTI interface. In accordance with one embodiment of the present invention, the ATE describes a single, testable aspect of a resource, device, or network devices of the network configuration. The ATE provides the most basic description of a source requirement. For instance, an ATE may specify a single part of a feature running on a specific set of hardware, in a specific network configuration for a source or customer.

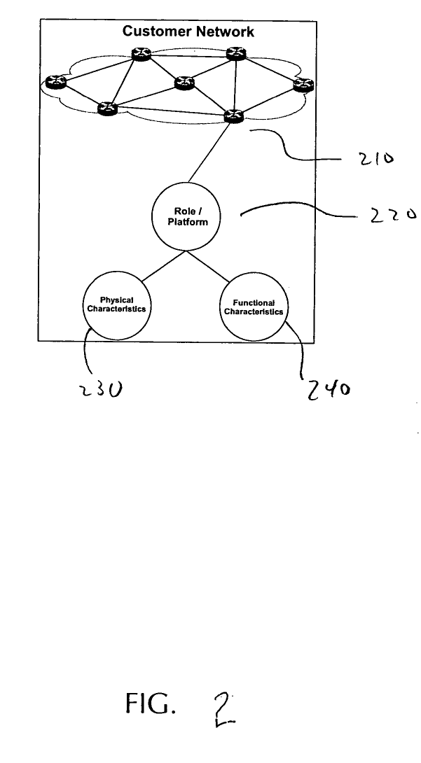

FIG. 2 is a diagram of a network 200 illustrating the functions of a network resource 210, in accordance with one embodiment of the present invention. The ATE can be used to describe system functions on the network resource 210, in one embodiment. As shown in FIG. 2, system functions operate on a physical piece of equipment (platform) that is performing a given function (role) within the network configuration 200. As a result, the resource 210 can be described as s unique role/platform combination 220.

In addition, the role/platform combination 220 describes both physical characteristics 230, as well as functional characteristics 240. The physical characteristics 230 described hardware configuration of the platform (e.g., resource 210). The functional characteristics 240 describe what the resource 210 does in the network, such as the list of features operating on the resource 210.

In one embodiment, the ATE is a schema that includes the following set of fields: Role, Platform Type, Line Card, Interface, Feature, and Attribute. In particular, the role field identifies the function the platform is performing within the network configuration. The platform type identifies the type of platform being used. A product may have one or more platform types. The Line Card identifies the type of line card used in the platform. The interface identifies the interface used in the line card, or platform type when a line card is not used. The feature identifies the functionality that is being performed on the platform. Attributes are used to identity key attributes of the feature.

As an implementation, the physicals characteristics of the resource 210 is defined using the Line Card and Interface fields, in one embodiment. Attributes for this feature include resource specific information, such as processor type, amount of memory and specific chassis type. Additionally, the functional characteristics of the resource 210 are defined using the feature and attribute fields.

Each of the fields have a limited set of “valid” choices, and the set of all possible combination is the set of all possible ATEs. The set of all possible ATEs describes every part of a product, resource, network configuration, that can be tested.

While ATEs provide an exact way to specify a single aspect of a product, resource, network configuration, many source requirements specify the testing of many of these aspects together, in accordance with one embodiment of the present invention. This is often referred to as system or solution testing. The common element, profiles, is a structured group of ATEs. That is, profiles are ATEs grouped in a structured way to describe how hardware and features are deployed in the configuration network. For instance, ATEs define what is deployed in the network configuration, and profiles define how these items are deployed din the network. The profiles are used to track solution and/or system test requirements, in one embodiment.

For example, to describe the behavior of a resource, product, or network configuration under test in live network, a number of features and hardware components must be tested simultaneously. Since each of these features/components can be described as an ATE, grouping of these ATEs together as a profile describes the simultaneous testing required.

In one embodiment, a structure is created around how ATEs can be grouped together. This ensures the method is common to all testing groups and has the widest possible applicability.

In addition, there are many ways to group ATEs, in another embodiment. Each type of grouping results in a new profile. In one embodiment, a grouping is based on the packet-forwarding functionality of a device in a network, and is grouped under a “packet flow profile.” In another embodiment, a grouping is based on the implementation of a control plane service across a network configuration, and is grouped under a “control plane profile.”

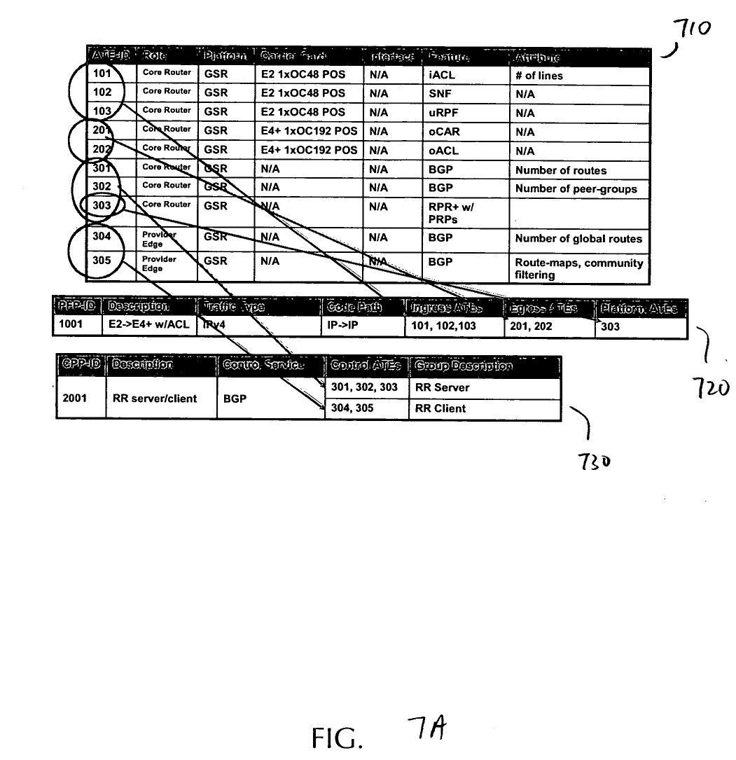

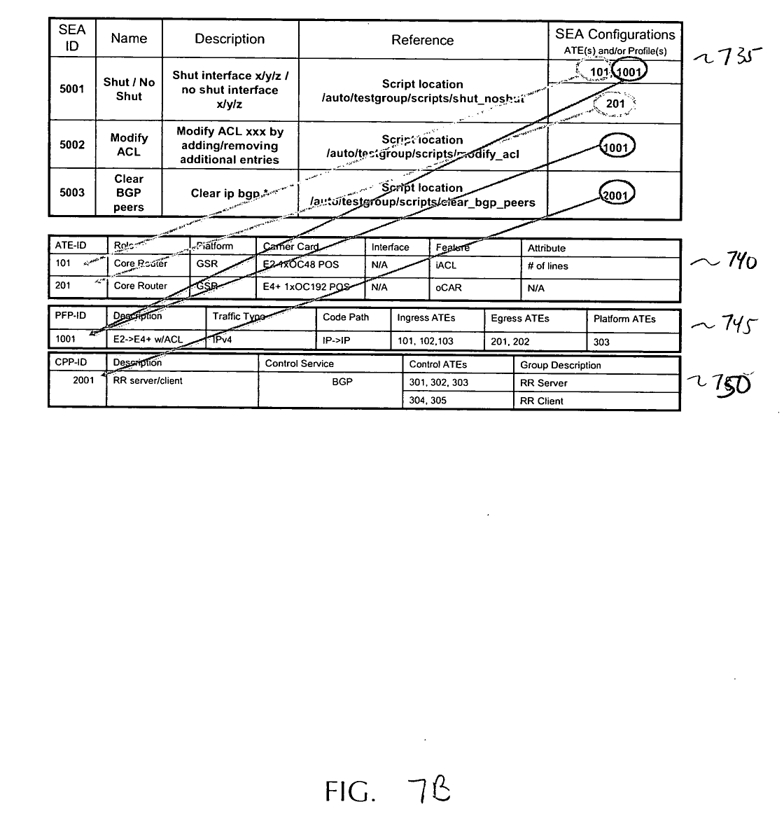

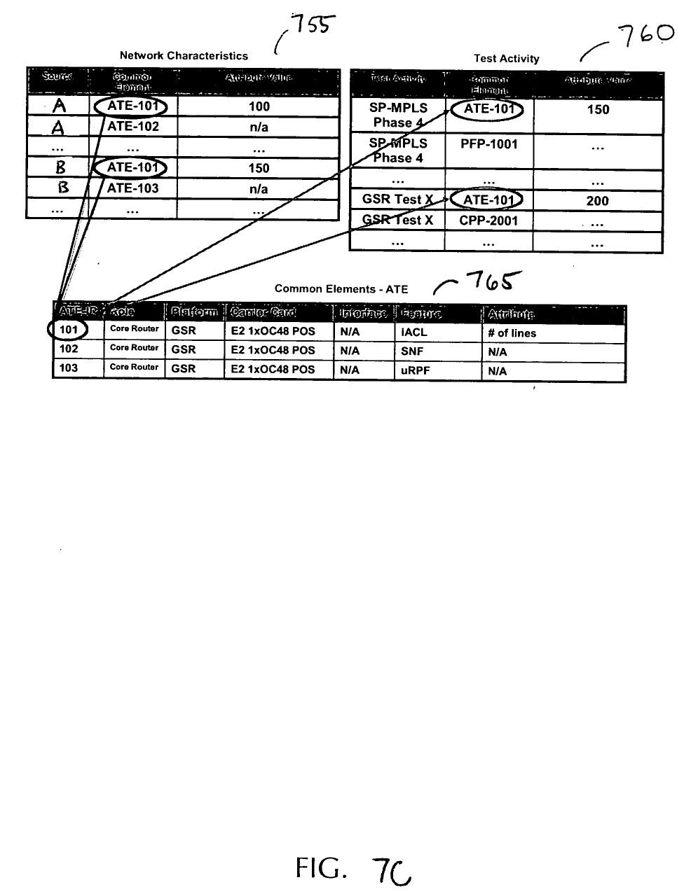

FIG. 7A is a diagram 700A illustrating the interrelationships between ATEs and packet flow profiles as well as control plane profiles, in accordance with one embodiment of the present invention. As shown in FIG. 7A, table 710 lists a portion of ATEs for a network configuration, as well as their associated set of fields (e.g., role, platform, carrier card or Line Card, interface, feature, and attribute). In addition, table 720 lists a packet flow profile with an identification number 1001. Also, FIG. 7A provides a table 730 that lists a control plane profile within an identification number 2001.

As shown in FIG. 7A, the ATEs as identified are linked to the associated packet flow profile or control plane profile. For example, the packet flow profile 1001 groups ATE identifiers 101, 102, and 103 for ingress ATEs. Also, ATE identifiers 201 and 202 are included within the group under egress ATEs. Also, a platform ATE 303 is provided in the group.

In accordance with anther embodiment of the present invention, a third common element is used to track objects which must be tested, but are not necessarily part of any product, such as stimulus, events, activities, etc. As such, these objects cannot be described using an ATE. For example, these objects can be simulated failures, transient events, provisioning tasks, etc. These types of common elements are referred to SEAs (stimulus, events, activates).

For instance, a stimulus is applied to the device to display and establish a steady state of a network configuration. As such, stimuli are factors that are ongoing, but which do not change the state of a testbed. Stimuli include: monitoring (SNMP polling, show commands, etc.) performed periodically, establishing certain scalability metrics (number of routes, etc.), which are persistent.

Events happen as a consequence of the stability of a network configuration. For instance, events include failure recovery, high-availability feature test, and other tests which require the testbed to recover or reconverge after a simulated failure.

Activities described provisioning for a network configuration. For instance, activities include provisioning, de-provisioning, routing metric changes, and upgrades etc.

FIG. 7B is a diagram 700B illustrating the interrelationships between SEAs, ATEs, and profiles, in accordance with one embodiment of the present invention. As shown in FIG. 7B, table 735 lists a portion of SEAs for a network configuration. In addition, table 740 lists a portion of ATEs for the network configuration, as well as their associated set of fields (e.g., role, platform, carrier card or Line Card, interface, feature, and attribute). In addition, table 745 lists a packet flow profile. Also, FIG. 7B provides a table 750 that lists a control plane profile.

As shown in FIG. 700B, an SEA may operate on multiple configurations. Each configuration is defined in terms of a combination of ATEs and profiles. As shown in table 735, multiple configurations for each SEA is shown. For example, the configuration of SEA identifier 5001 includes the ATE 101 and packet flow profile 1001.

The common elements define the essence of testable requirements and are used to describe both source and test requirements, in accordance with one embodiment of the present invention. Within the CTI interface, source requirements are referred to as Network Characteristics which identifies the set of “Common Elements” that apply to the source (e.g., customer), as well as the corresponding attribute values. For instance, network characteristics list a source requirement for a network configuration (per source) in terms of CTI common elements. Additional information for network characteristics include deployment plans for each source requirement, relative importance to the source, unique combinations of equipment and features, in one embodiment. Likewise, test requirements are organized per Test Activity which identifies the set of “Common Elements” included in a given test, as well as the corresponding attribute values used for the test.

As a result, the source environment as described by source requirements are linked with the test environment, as described by test requirement, through the common elements. This interrelationship is shown in FIG. 7C, which includes a diagram 700C illustrating the interrelationship between Network Characteristics and Test Activities through common elements, in one embodiment. For example, table 755 provides a portion of a list of network characteristics (e.g., ATE 101) for various sources (e.g., company A and company B). Table 760 provides a list of test activities that are defined by a common element. For example, the test activity SP-MPLS, Phase 4 is defined or associated with common element 101. As a result, the common element 101 can be used to link between network characteristics defining source requirements and test activities providing test results for corresponding test requirements that test the source requirements.

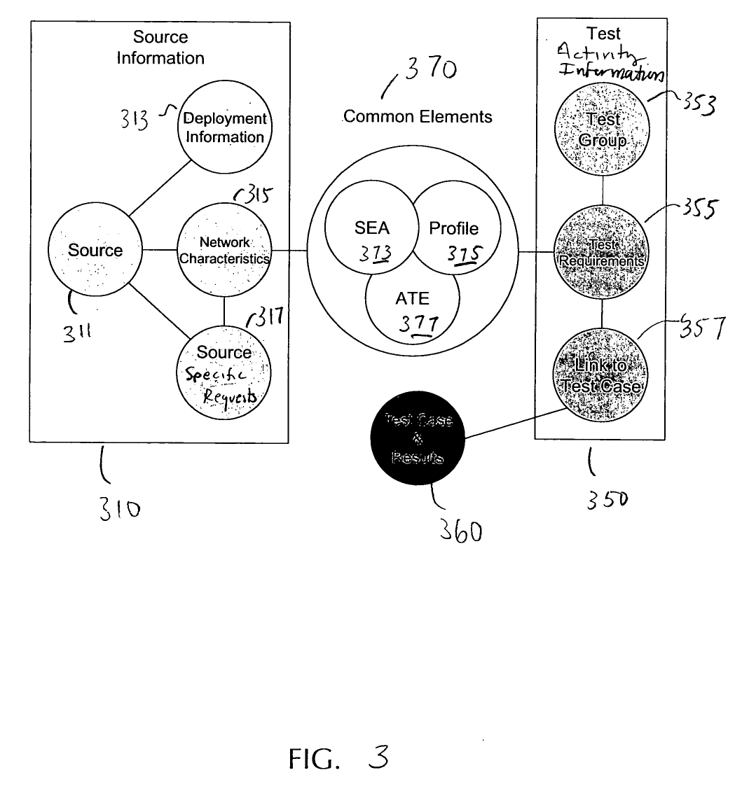

FIG. 3 is a data flow diagram 300 illustrating the interrelationship between a source defined network configuration design environment and a testing environment testing the network configuration, in accordance with one embodiment of the present invention. The data flow diagram 300 links the source block 310 and the testing block 350 through the use of common elements 370.

As shown in FIG. 3, the source block is representative of source requirements for a source (e.g., customer). Source information includes source characteristics 311, including high level information such as source name and contact information. The source information also includes network characteristics 315 (e.g., ATEs, profiles, SEAs), as previously defined. In addition, deployment information 313 includes current and planned software release information. This information can be used to understand customer migration plans and help determine appropriate software releases for testing. Also, the source information for source block 310 includes source specific requests 317. These source specific requests 317 are defined by the source for testing by the testing groups in testing block 350. The source specific requests 317 are mapped to a set of network characteristics 315 so that they can be tested and tracked together.

Also shown in FIG. 3 is the testing block 350 which provides test information. The test block identifies test activities which are a discreet set of tests performed by a test group 353. The test group is a unique test organization. Other test groups can also be represented, in another embodiment. As such, the testing block tests the testable source requirements as defined by the source block 310. Each of the source requirements that are identified for testing is associated with a test requirement.

The test requirements are used as an aide to plan test activities. That is, test teams can plan and prioritize test activities based upon source requirements associated with the source. A test activity is the component used to group testing efforts within a test group. Each test group could have multiple test activities. For example, test activities can be organized on a per test bed, technology area, customer, software image, and any combination of these, etc.

The test requirements component 355 is used to identify items to be tested in terms of the common elements for a given test activity. The test requirements component 355 can also store additional state, priority, timeframe information, etc.

In addition, each source requirement that is covered in a test activity of block 350 is linked to a corresponding test requirement. The test requirement is linked to a corresponding test case 360 along with corresponding test results. This link is provided in the link to test case 357 module. The link module 357 connects a test requirement to a test case and includes the relevant attribute value used for the test. In particular, a test requirement can be used in more than one test case. Likewise, a test case can address more than one test requirement.

Additionally, in accordance with another embodiment, common elements are used to capture commonality between source requirements and test requirements. As such, an advantage to building test requirements based upon common elements is to facilitate test underlap and overlap analysis across test activities, in accordance with one embodiment of the present invention.

Furthermore, in accordance with another embodiment, a “similar to ID” field provides further linkage among test requirements that are similar to each other. In that case, test results from testing one test requirement may be substituted as test results for the similar test requirement.

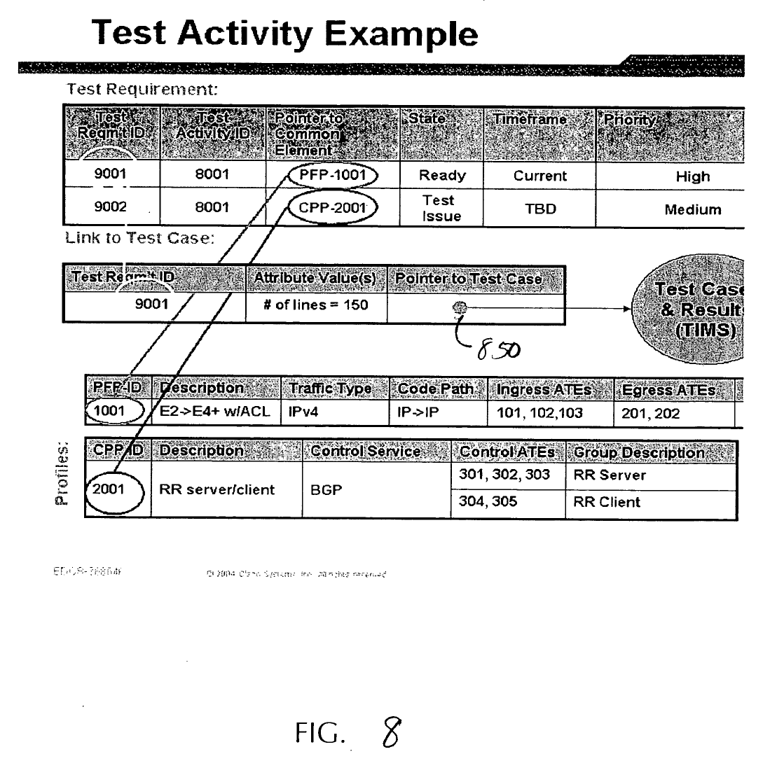

FIG. 8 provides a diagram 800 illustrating the interrelationship between the source block and the testing blocks, in accordance with one embodiment of the present invention. In diagram 800, the packet flow profile identifier 1001 and the control plane profile identifier 2001 are common elements as selected (e.g., by a test engineer) for inclusion the test requirements list. For instance the test requirement identifier 9001 corresponds to testing of the packet flow profile identifier 1001, and test requirement identifier 9002 corresponds to testing of the control plane profile identifier 2001.

A test case has been developed for test requirement identifier 9001. The attribute “# of lines” value is thus associated with the packet flow profile identifier 1001. The pointer 850 links the test requirement identifier 9001 to the corresponding test case, and its results.

As shown in FIG. 3, the CTI interface utilizes a set of common elements 370 which are used to describe source requirements from sources or customers, and used to describe test requirements from the testing community, where the test requirements are requirements for testing. As shown in FIG. 3, the set of common elements 370 include the ATE 377, profiles 375, and SEAs 373.

The ATEs, profiles, and SEAs, as common elements, link together test requirements to multiple source requirements for various tracking purposes. That is, the common elements are mapped to detailed test results, in one embodiment.

In accordance with one embodiment of the present invention, the common elements are mapped to detailed test results obtained from existing tracking systems. However, the CTI interface of the present embodiment extends the existing tracking systems to include a test result to common element mapping. Thus, each test result that is stored in the tracking system is linked to a common element. As such, an index is created through the common element for retrieval and access to detailed test results for corresponding source requirements.

As a result, embodiments of the present invention utilize common elements to describe any test performed, source requirement, test requirement. The use of common elements to map quickly between source requirements, test requirements, and test results allow for quick and efficient gap analysis, efficiency measurements, and quality evaluations, when testing network configurations.

For example, as an illustration of the increase in efficiency when testing multiple network configurations, one embodiment of the present invention is able to run one test case in a test activity for testing two different source requirements for one or more sources. For instance, a customer A has a source requirement A. This source requirement A can be expressed by packet flow profile identifier 101 (PFP #101). A different customer B also has a different source requirement, source requirement B. However, the source requirement B can also be expressed by PFP #101. Thus, both of these source requirements (requirements A and B) can be tested in one test, which tests PFP #101. The present embodiment increases the testing efficiency, since one test, rather than two tests, are conducted to test both source requirements A and B.

As a result testing results for a particular common element need only be tested once for a multitude of platforms, and network configurations that are associated with that common element. The same test result can be used for various sources using the same common element to define source requirements. In addition, test overlay between two or more testing groups can be avoided, since a test result for a common element need only be determined once. Also, the present embodiment is able to identify the same features of a platform used in different network configurations.

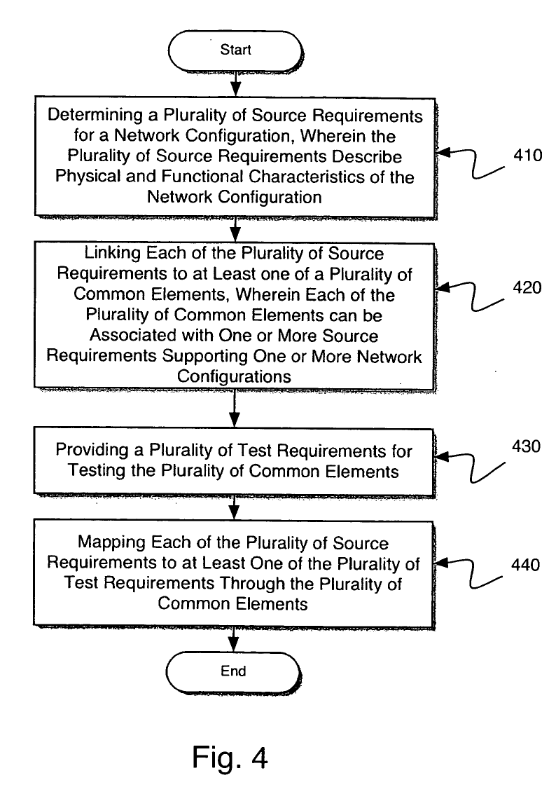

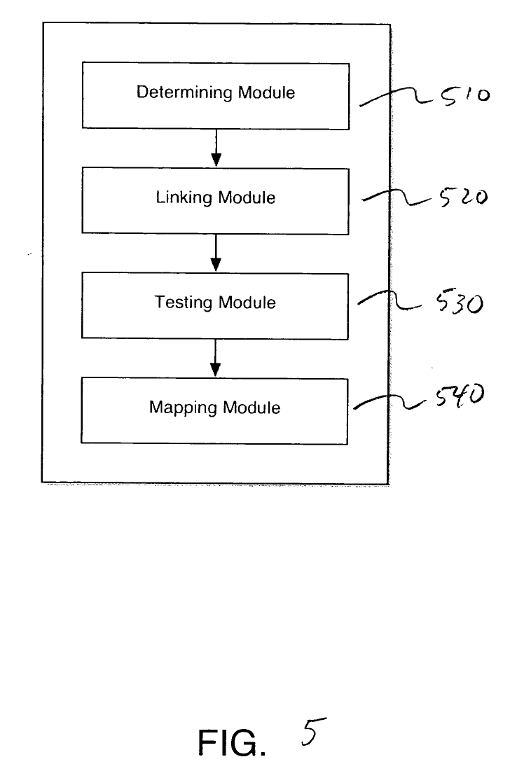

FIGS. 4 and 5 in combination describe a method and system for testing network configurations through a common test interface that links source requirements and test results through the use of common elements in a structured language or schema. FIG. 4 illustrates the method for testing network configurations and FIG. 5 illustrates a CTI system 500 that implements the method for testing network configurations of FIG. 4, in accordance with one embodiment.

Referring now to FIG. 4, a flow chart 400 is described illustrating steps in a computer implemented method for testing network configurations, in accordance with one embodiment of the present invention. The method provides a bridge between test activities/requirements and source requirements used in designing a network environment.

At 410, the present embodiment determines a plurality of source requirements for a network configuration. The operation of 410 is performed by the determining module 510 of system 500, in one embodiment. That is, the determining module defines a plurality of source requirements that characterize a network configuration, as previously described in relation to FIGS. 2 and 3. As such, the plurality of source requirements describe physical and functional characteristics of the network configuration.

In one embodiment, as source requirements are selected within the CTI interface, the list of available options for other source requirements and network characteristics available to the user is tailored to previous selections. That is, the design of the network configuration is displayed in a “hierarchical” tree structure. Formation of the tree is dependent on the previous source requirement selections. In this manner, the CTI interface is able to walk an end user through the design of the network configuration that results in a plurality of common elements associated with that network configuration.

At 420, the present embodiment links each of the plurality of source requirements to at least one of a plurality of common elements. The operation of 420 is performed by the linking module 520 of system 500, in one embodiment. More specifically, the linking module 520 associates each of the plurality of common elements with one or more source requirements supporting one or more network configurations. As such, the CTI interface of the present embodiment is able to efficiently test source requirements associated with common elements even though the source requirements may be associated with different network configurations. This allows for efficiency in scale by testing a test requirement associated with a single common element only once.

At 430, the present embodiment provides a plurality of test requirements for testing the plurality of common elements. The operation of 430 is performed by the testing module 530 of system 500, in one embodiment. That is, during the testing phase, given a test activity association, the test team searches to discover a set of test requirements which consists of testing common elements in a one-to-one relationship. As such, the testing module 530 associated with one or more testing groups as a whole will test al the common elements associated with a particular network configuration, as defined by corresponding source requirements.

For broader applicability, the present embodiment is able to link two or more test requirements, associated with at least one network configuration, to a single common element. That is, the single common element is associated with various test requirement, and can be tested by any of those test requirements.

At 440, the present embodiment maps each of the plurality of source requirements to at least one of the plurality of test requirements through the plurality of common elements. The operation of 440 is performed by the mapping module 540, in one embodiment. In this manner, the CTI interface of the present embodiment is able to link source requirements of a source environment to a test requirement of a testing environment through a common element. As a result, test results obtained from testing test cases testing the common element can also be associated with the source requirement.

In this manner, by mapping each of the source requirement to a test requirement and its corresponding test result, one embodiment of the present invention is able to validate the plurality of source requirements of the network configuration. This is accomplished by tracking results of test cases that test the plurality of test requirements. The test results are linked back to the source requirements through the corresponding common element.

In one embodiment of the present invention, a web based interface is provided for the CTI interface. That is, the web based interface provides means for designing the network configuration by determining the plurality of source requirements. In addition, the web based interface provides means for performing the validation of the plurality of source requirements. That is, a user can check the status of a test requirement that tests a common element that is associated with a particular source requirement.

One embodiment of the present invention is capable of determining if a plurality of network resources, or devices that comprise the network configuration is able to support the plurality of source requirements used to design the network configuration. More specifically, as common elements are selected that are associated with the source requirements designing a network configuration, the present embodiment can determine if the network characteristics (e.g., the physical devices of the network configuration) is able to support the source requirements selected. If the network characteristics do not support the source requirements, the present embodiment flags the situation and can provide suggestions that allow for support of the source requirements.

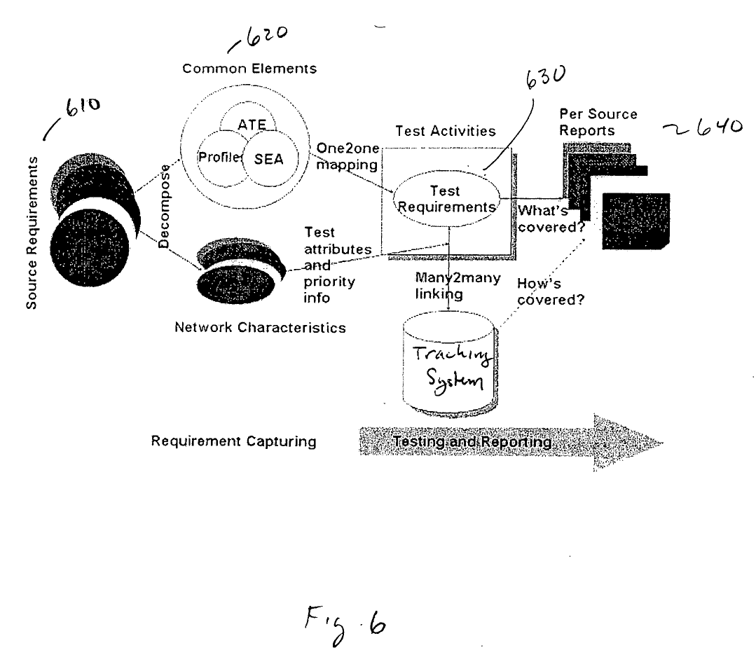

FIG. 6 is a diagram of a CTI interface network 600 that is capable of testing a network configuration. FIG. 6 illustrates the entire CTI process, in accordance with one embodiment of the present invention. The CTI process starts from the capturing of source requirements 610. The source requirements originate from various sources (customer or internal sources. The source requirements are then decomposed to a set of common elements 620. The set of common elements is defined in terms of ATEs, profiles, SEAs, source specific Network Characteristics. During the test phase, given a test activity goal for a particular test group, the test group is able to filter the world of CTI database, linking common elements to source requirements, to define a set of test requirements. The set of test requirements consist of common elements in one-to-one relationship. In addition, the test requirements also include other information as test requirement state, priority, timeframe, etc.

At the same time, the identified test requirements are linked to test cases that are stored and managed in a tracking system. The test cases provide details on how those test requirements are being tested. For example, test attribute values are provided as test results. As a result, the CTI system, in accordance with one embodiment, shall be able to answer, for a given source, test coverage at the requirement level, which testing groups are conducting the test activities, where to find detailed test case information, and what are current results (e.g., pass or fail) at a test requirement level. Test reports are derived for each of the source requirements, in one embodiment.

Accordingly, various embodiments of the present invention disclose a method and system for testing a network configuration through a common test interface that links source requirements used to design the network configuration and test requirements used to test the source requirements. Embodiments of the present invention are capable of track source requirements and report results across various platforms and across various network configurations. As such, embodiments of the present invention are capable of track testing and source requirements for more than one customer and all testing groups using one language or schema implementing the CTI interface.

While the methods of embodiments illustrated in flow chart 400 show specific sequences and quantity of steps, the present invention is suitable to alternative embodiments. For example, not all the steps provided for in the method are required for the present invention. Furthermore, additional steps can be added to the steps presented in the present embodiment. Likewise, the sequences of steps can be modified depending upon the application.

Embodiments of the present invention, a method and system for testing network configurations using a common test interface are described. While the invention is described in conjunction with the preferred embodiments, it is understood that they are not intended to limit the invention to these embodiments. On the contrary, the invention is intended to cover alternatives, modifications and equivalents, which may be included within the spirit and scope of the invention as defined by the appended claims. Furthermore, in the detailed description of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the present invention.

What is claimed is:

1. A method for testing network configurations, comprising:
determining a plurality of source requirements for a network configuration, wherein said plurality of source requirements describe physical and functional characteristics of said network configuration;
linking each of said plurality of source requirements to at least one of a plurality of common elements, wherein each of said plurality of common elements can be associated with one or more source requirements supporting one or more network configurations;
providing a plurality of test requirements for testing said plurality of common elements; and
mapping each of said plurality of source requirements to at least one of said plurality of test requirements through said plurality of common elements.

2. The method of claim 1, wherein said linking each of said plurality of source requirements further comprises:
linking a source requirement to a common element taken from a group consisting essentially of an Atomic Test Element (ATE), a profile that group two or more associated ATEs, and an SEA (Stimulus, Event, or Activity).

3. The method of claim 1, wherein said profile is taken from a group consisting essentially of a packet flow profile and a control plane profile

4. The method of claim 1, further comprising:
validating said plurality of source requirements of said network configuration by tracking results of test cases testing said plurality of test requirements.

5. The method of claim 4, further comprising:
providing a web based interface for performing said validating said plurality of source requirements.

6. The method of claim 1, further comprising:
linking two or more test requirements associated with at least one network configuration to a single common element through a network interface.

7. The method of claim 1, further comprising:
determining if a plurality of network resources comprising said network configuration support said plurality of source requirements.

8. A system for testing network configurations, comprising:
a plurality of source requirements defining at least one network configuration;
a plurality of common elements associated with said plurality of source requirements;
a plurality of test requirements for testing common elements of said plurality of common elements; and a mapper for mapping said plurality of common elements to said plurality of source requirements and to said plurality of test requirements, such that a mapping exists between a source requirement and a test requirement through an associated common element.

9. The system of claim 8, wherein said plurality of common elements is taken from a group consisting essentially of Atomic Test Elements (ATEs), Profiles, and SEAs (Stimulus, Events, and Activities).

10. The system of claim 8, further comprising:
a tracking system for tracking testing of a test case testing at least one of said plurality of test requirements.

11. A system for testing network configurations, comprising:
means for determining a plurality of source requirements for a network configuration, wherein said plurality of source requirements describe physical and functional characteristics of said network configuration;
means for linking each of said plurality of source requirements to at least one of a plurality of common elements, wherein each of said plurality of common elements can be associated with one or more source requirements supporting one or more network configurations;
means for providing a plurality of test requirements for testing said plurality of common elements; and
means for mapping each of said plurality of source requirements to at least one of said plurality of test requirements through said plurality of common elements.

12. A computer system comprising:
a bus; and
a computer-readable memory coupled to said processor and containing program instructions that, when executed, implement a method for testing network configurations, comprising:
determining a plurality of source requirements for a network configuration, wherein said plurality of source requirements describe physical and functional characteristics of said network configuration;
linking each of said plurality of source requirements to at least one of a plurality of common elements, wherein each of said plurality of common elements can be associated with one or more source requirements supporting one or more network configurations;
providing a plurality of test requirements for testing said plurality of common elements; and
mapping each of said plurality of source requirements to at least one of said plurality of test requirements through said plurality of common elements.

13. A computer-readable medium comprising computer executable instructions for performing a method for testing network configurations, said instructions comprising:
determining a plurality of source requirements for a network configuration, wherein said plurality of source requirements describe physical and functional characteristics of said network configuration;
linking each of said plurality of source requirements to at least one of a plurality of common elements, wherein each of said plurality of common elements can be associated with one or more source requirements supporting one or more network configurations;
providing a plurality of test requirements for testing said plurality of common elements; and
mapping each of said plurality of source requirements to at least one of said plurality of test requirements through said plurality of common elements.

14. The computer readable medium of claim 13, wherein said instructions for linking each of said plurality of source requirements further comprises additional instructions which when executed perform said method for testing network configurations, said additional instructions comprising:
linking a source requirement to a common element taken from a group consisting essentially of an Atomic Test Element (ATE), a profile that group two or more associated ATEs, and an SEA (Stimulus, Event, or Activity).

15. The computer readable medium of claim 13, wherein said instructions further comprises additional instructions which when executed perform said method for testing network configurations, said additional instructions comprising:
validating said plurality of source requirements of said network configuration by tracking results of test cases testing said plurality of test requirements.

16. The computer readable medium of claim 15, wherein said instructions for validating said plurality of source requirements further comprises:
providing a web based interface for performing said validating said plurality of source requirements.

17. The computer readable medium of claim 13, wherein said instructions further comprises additional instructions which when executed perform said method for testing network configurations, said additional instructions comprising:
linking two or more test requirements associated with at least one network configuration to a single common element through a network interface.
